(19) United States
(12) Patent Application Publication
(10) Pub. No.: US 2017/0027187 A1
(43) Pub. Date: Feb. 2, 2017

(54) RIGID AGITATOR FOR BLENDER SYSTEM

(71) Applicant: Vita Mix Management Corporation, Olmsted Township, OH (US)

(72) Inventors: Maccrea W. Monteith, Olmsted Township, OH (US); Joseph M. Hobbs, Olmsted Township, OH (US)

(21) Appl. No.: 15/224,775

(22) Filed: Aug. 1, 2016

Related U.S. Application Data
(60) Provisional application No. 62/199,789, filed on Jul. 31, 2015.

(51) Int. Cl. A23G 9/22; A47J 31/44; B01F 7/00

(52) U.S. Cl. CPC A23G 9/224; B01F 7/0025; B01F 7/00033; A47J 31/4403; A23V 2002/00; B01F 2215/0021

(57) ABSTRACT

An agitator assembly for mixing a product in a container is provided. The agitator assembly may include an arm member having a distal end and an opposite proximal end. An agitator head may be disposed proximal to the distal end of the shaft. The agitator head may include a rigid material for mixing viscous products. The agitator head may include movement formations. The movement formations may include a swept-blend, knife-like protrusions, and diamond-like shapes.

### RELATED APPLICATIONS

This application claims the benefit of U.S. Provisional Patent Application Ser. No. 62/199,789, filed Jul. 31, 2015, and entitled “RIGID AGITATOR FOR REDUCED MATERIAL LOSS,” the entirety of which is incorporated herein by reference.

### FIELD OF THE INVENTION

The present disclosure generally relates to an agitator assembly and, more particularly, to food mixing machines having a rotatable shaft and an agitator head.

### BACKGROUND

Popular food items are those commonly referred to as “frozen” shakes or drinks, whereby a portion of liquid, and/or a flavored drink mix or syrup, and a portion of ice cream or frozen yogurt may be mixed together in a mixing apparatus or blender to create an almost slush-like drink. In the past, the most typical manner to create such drinks may have required an operator to put a quantity of flavored liquid, ice cream, and possibly other ingredients, such as fruit, candy, nuts and the like, in a cup of an ice cream mixing machine, and, thereafter, operate the machine until the frozen drink is perceived to be adequately mixed. The frozen drink may then be transferred from the cup of the machine to a patron's glass for consumption.

However, as it particularly relates to ice cream, frozen yogurt or other types of high viscous products, many frozen drink mixing machines have trouble reducing the viscosity of the product to allow it to be consumable through a straw. Additionally, many of these machines have trouble mixing in additional treats such as, but not limited to, chunks of candy bars, chocolate bits, sprinkles, nuts, fruit, candies, cereals, or any other types of additional additives that may be added to a frozen product. Further, another problem facing ice cream-type mixing machines that are automated is that they need to be configured to automatically mix product within a wide range of container sizes.

Current mixing agitators require that the user vertically displace the cup containing the product along a stroke range or, in the case of an automated machine, require that an agitator axially translate a stroke length relative to the position of the cup containing the product. This stroke range is in addition to the rotation of the agitator about its center axis to ensure that the product is properly mixed. These automated machines that either displace the cup or translate the agitator are required to have extra space to house the mechanisms that induce this automated motion. The mechanisms take up space in order to accommodate the stroke range required to either displace the cup receptacle or translate the agitator for a variety of cup sizes. This usage of space is often undesirable as space in general is at a premium in a restaurant or quick-serve, kitchen-type area. Additionally, machines having additional height can also create challenges for shorter operators who prepare the product.

Current agitators with a fixed vertical stroke length struggle to adequately blend through the entire range of cup sizes for use in these automated machines. Additionally, when the container or agitator translates along a stroke range, the rotating agitator may abut against the bottom, walls or lid of the container thereby causing damage to the container.

Further, current agitators may capture a substantial amount of blended product thereon after the conclusion of a mixing cycle. The resulting product loss may be as much as 15% of the final served product. It may take additional time to recapture the product disposed along the agitator and the act of recapturing the lost product introduces risks related to sanitation. This usually results in the user blending additional product than as required per serving size, which translates into wasted product and lost profit margin.

However, many container sizes today have larger vertical profiles and relatively smaller radial profiles. As such, when the container capacity exceeds a particular size, such as for example, 12 to 18 fluid ounces, the performance of known agitators is reduced dramatically. Therefore, there is a need for a more efficient design for an agitator assembly that is configured to efficiently mix product in a thorough manner. Additionally, there is a need for an agitator assembly that is configured to mix product in a container made of plastic or other semi-rigid material without damaging the container.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

The present disclosure relates to an agitator and a blending system. The blending system may include a motor. The motor may drive the agitator to mix foodstuff within a container. The agitator may comprise an agitator head, an arm portion, and a connector portion. The connector portion may connect to a drive shaft of a motor. The arm portion may extend from the connector portion to support the agitator head. The agitator head may revolve about an axis to mix foodstuff within a container. In an aspect, the agitator may comprise a rigid material. The material may be sufficiently rigid to move a viscous product.

In another aspect, an agitator head may comprise a diamond-like shape that may allow for efficient and effective mixing. The agitator may comprise a curved body or swept-blend area, which may comprise edges. The edges may force material above or below the swept-blend. The agitator head may include knife-like protrusions that extend outwardly from a vertical axis. The protrusions and the swept-blend areas may mix a product in both vertical and horizontal directions.

In an embodiment, an agitator head may include a first agitator head portion and a second agitator head portion. Each head portion may comprise similar aspects or configurations. For instance, the first agitator head portion and the second agitator head portion may respectively include a first swept-blending area and a second swept-blending area. In another aspect, the first agitator head portion and the second agitator head portion may respectively include a first set of knife-like edges and a second set of knife-like edges.

Disclosed agitator heads may include one or more apertures formed through the agitator heads. The apertures may allow for foodstuff to flow therethrough. The flow of foodstuff through the agitators may reduce an amount of stress on the agitator head and/or a motor. In another aspect, the apertures may allow for a more effective and efficient blending process.

The following description and drawings disclose various illustrative aspects. Some improvements and novel aspects may be expressly identified, while others may be apparent from the description and drawings.

### BRIEF DESCRIPTION OF THE DRAWINGS

Objects and advantages, together with the operation of the disclosure, may be better understood by reference to the following detailed description taken in connection with the following illustrations.

FIG. 1 illustrates a front view of an agitator assembly in an embodiment of the present disclosure.

FIG. 2 illustrates a side view of the agitator assembly of FIG. 1.

FIG. 3 illustrates a top view of the agitator assembly of FIG. 1.

FIG. 4 illustrates a bottom view of the agitator assembly of FIG. 1.

FIG. 5 illustrates a top and partial, cross-sectional view of the agitator head of the agitator assembly of FIG. 1.

FIG. 6 illustrates an enlarged side view of the agitator head of the agitator assembly of FIG. 1.

FIG. 7 illustrates a front view of a multi-head agitator assembly in an embodiment of the present invention.

FIG. 8 illustrates a side view of the multi-head agitator assembly of FIG. 7.

FIG. 9 illustrates an enlarged side view of the agitator head of the agitator assembly of FIG. 7.

FIG. 10 illustrates a front view of a multi-head agitator assembly with two rounded swept-blends in an embodiment of the present disclosure.

FIG. 11 illustrates a front view of another multi-head agitator assembly in an embodiment of the present disclosure.

FIG. 12 illustrates a front view of a modular arm member in an embodiment of the present disclosure.

FIG. 13 illustrates a front view of an agitator assembly including the modular arm member of FIG. 12 in an embodiment of the present disclosure.

FIG. 14 illustrates a front view of a blender system including an agitator in an embodiment of the present disclosure.

### DETAILED DESCRIPTION

Reference will now be made in detail to exemplary embodiments of the present disclosure, examples of which are illustrated in the accompanying drawings. It is to be understood that other embodiments may be utilized and, structural and functional changes may be made without departing from the respective scope of the disclosure. As such, the following description is presented by way of illustration only and should not limit in any way the various alternatives and modifications that may be made to the illustrated embodiments and still be within the spirit and scope of the disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Furthermore, as used herein, the words “coupled,” “attached,” “connect,” and the like are utilized interchangeably unless context suggests otherwise. Such terms may mean removably or irremovably coupled. Furthermore, such terms may mean that articles or components may be or are capable of being coupled together. For instance, “G coupled with H” may mean that G is removably coupled with H, G is irremovably coupled with H, or G is capable of being coupled with H.

While embodiments may refer to particular shapes, it is noted that such references are intended to include irregular shapes that generally represent the referenced shapes unless context warrants a particular distinction among such terms. For instance, a “diamond shape” or “diamond-like shape” may refer to a shape with four straight sides that meet to form two wide and two narrow angles, rounded diamond-like shapes, almond-like shapes, rotated rectangular shapes, and the like.

It is further noted that the various embodiments described herein may include other components and/or functionality. While embodiments may refer to a blender or a blender system, various other systems may be utilized in view of the described embodiments. For example, embodiments may be utilized in food processor systems, spice grinder systems, coffee grinder systems, mixing systems, hand-held blending systems, various other food preparation systems, and the likes. As such, references to a blender, blender system, and the likes, are understood to include food processor systems, and other mixing systems. Such systems generally include a blender base that may include a motor, a blade assembly, and a controller.

Moreover, blending of foodstuff or ingredients may result in a blended product. Such blended products may include drinks, frozen drinks, smoothies, shakes, soups, purees, sorbets, butter (nut), dips or the likes. It is noted that various other blended products may result from blending ingredients. Accordingly, terms such as “blended product” or “drink” may be used interchangeably unless context suggests otherwise or warrants a particular distinction among such terms. Further, such terms are not intended to limit possible blended products and should be viewed as examples of possible blended products.

In some traditional systems, a user or a machine may be required to move a cup up and down (e.g., or in other directions) to change the relative position of a mixing head within the cup. In other systems, the mixing head may be moved (e.g., by a user or a machine) to alter the position of the mixing head within the cup. This movement may require additional space within a machine and/or around the machine. Space is often highly valuable within food preparation areas. In another aspect, traditional mixing heads may leave a large amount of material stuck to the mixing head, particularly when mixing viscous products (e.g., milkshakes, smoothies, etc.). This material may result in wasted product and may reduce the overall efficiency of a mixing head.

The traditional agitators have a relatively short vertical profile with respect to the overall height of the machine and a relatively large radial profile when viewed from a line of sight parallel to the axis of the agitator. The short vertical profile may allow a machine to be constrained by height, while the relatively large radial profile allows for agitation of a product in the vertical direction. The relatively large radial profile of the agitator required to produce an effective blend through that entire range of sizes of cups may cause these agitators to capture a substantial amount of material. The traditional agitators have increased difficulty with portion sizes of 18 oz. Larger portions (e.g., more than 18 oz.) can yield more profit margin, so it may be fiscally desirable to be able to process portions larger than 18 oz. Traditional agitators, however, struggle to produce an effective blend above this 18 oz. portion size.

As described herein, embodiments of the disclosed agitators may comprise a decreased radial cross-section from a top down view. Whereas, traditional agitators have had relatively larger radial cross-sections from the top down view. Further, described embodiments may comprise move features (e.g., knife-like edges, swept-blends, etc.) that may be perpendicular to that cross-section.

Embodiments described in this disclosure generally relate to an agitator for mixing of foodstuff. The agitator may primarily include a connector portion or attachment member (which may be configured to attach to a spindle of a motor), an arm portion or shaft, and an agitator head (which may be configured to agitate foodstuff). For instance, the agitator may be rotatably attached to a motor such that the motor may drive the agitator to rotate about an axis.

In at least one embodiment, disclosed agitators may be particularly well suited for mixing of viscous products, such as milkshakes, smoothies, foams, and the like. Such products may include chunks of candy bars or other similar treats that may be difficult to blend with traditional agitators. Mixing of viscous products may be designed to reduce the viscosity of the product, such as to allow drinking through a straw, and/or to evenly mix the foodstuff (e.g., disperse pieces of candy bars throughout the product). In another aspect, the disclosed agitators may be utilized to blend foodstuff in portions of, but not limited to, 18 oz. to 24 oz. In embodiments, such agitators may be configured to reduce breakage or damage to containers (e.g., cups, bowls, etc.), reduce wasted material, alter (e.g., decrease) blend time, alter (e.g., improve) blended consistency, and/or increase overall user satisfaction with respect to traditional systems.

In another aspect, an agitator assembly for a blending system, the agitator assembly may comprise an arm extending from a first end to a second end, the arm operatively attached to a blender device at the first end, and an agitator head disposed at the second end of the arm and comprising a curved body. The body may comprise a swept-blend area comprise a curved body, an external edge about a perimeter of the body, and a inner edge, wherein a thickness of the body decreases from the inner edge towards the external edge. The body, in addition, may include at least one aperture disposed proximal a central axis of the body, wherein the thickness of the body generally decreases from the inner edge towards the at least one aperture

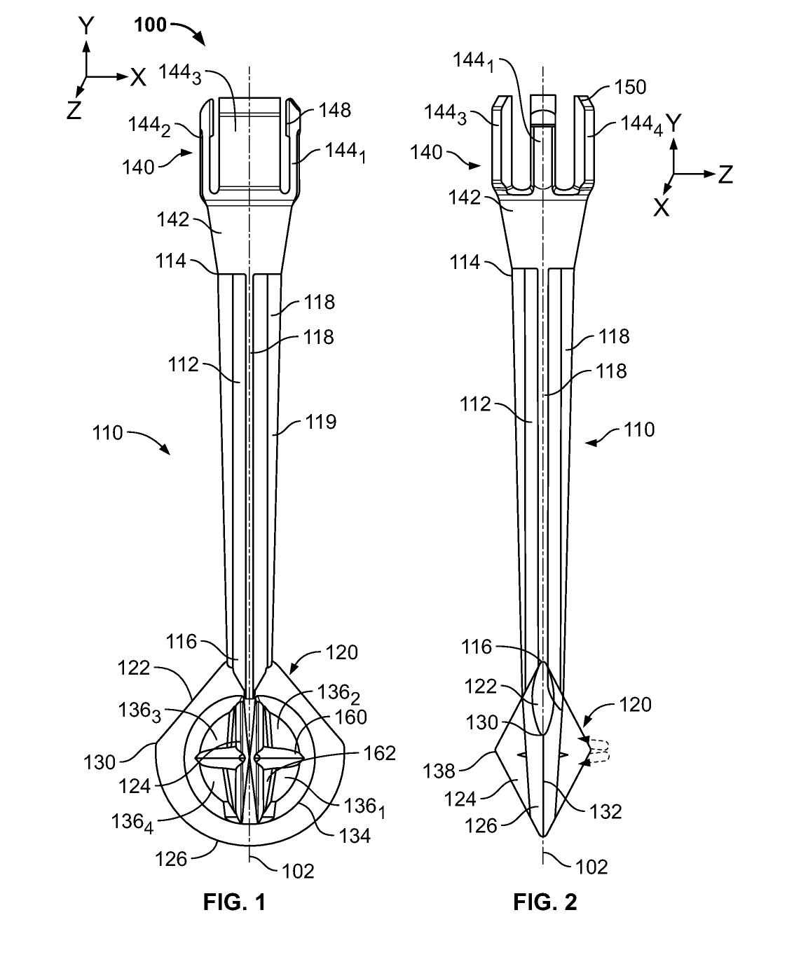

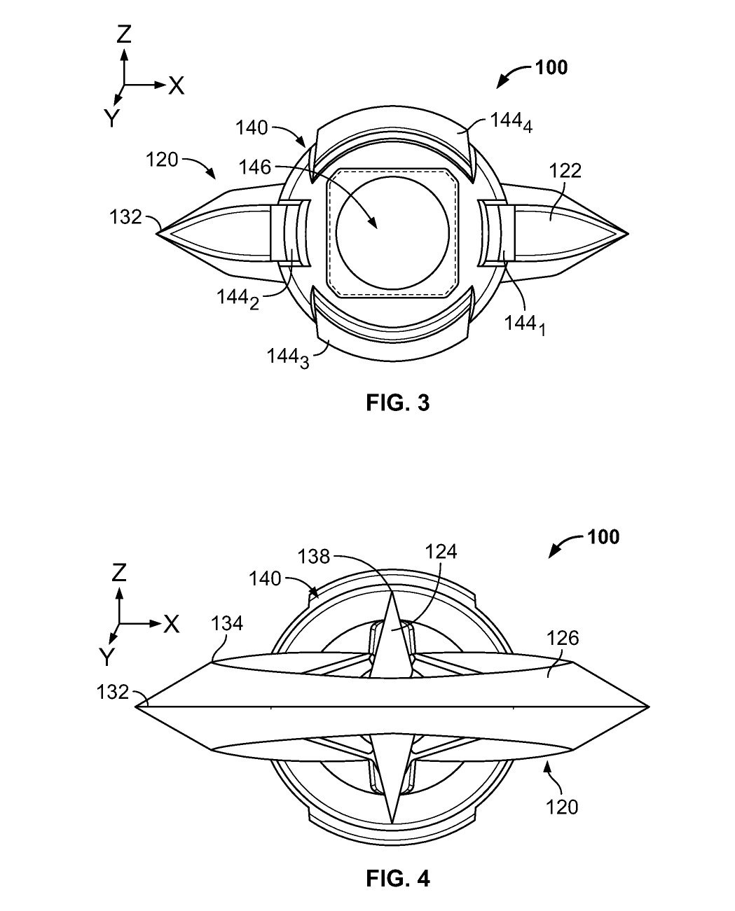

Referring now to FIGS. 1-6, illustrated are various views of an agitator assembly 100. The agitator assembly 100 may be utilized with and/or may be part of a larger system, such as a blender system (e.g., as depicted in FIG. 13) that may be configured to blend, mix, or agitate foodstuff For instance, the agitator assembly 100 may be attached to a motor to rotatably move about an axis 102. In another aspect, the agitator assembly 100 may be placed within a blender container, such as a cup, pitcher, or the like.

The agitator assembly 100 may comprise an arm portion 110, an agitator body and/or agitator head 120, and a connector portion 140. The arm portion 110, agitator head 120, and connector portion 140 may be monolithically formed or may comprise separate constructions. For instance, the agitator assembly 100 may comprise a single molded or printed construction, separately formed components attached together, or the like. Such components may comprise one or more materials such as metal, plastic, rubber, wood, or the like. In one example, the agitator assembly 100 may comprise a rigid, food-grade plastic that may be capable of withstanding high speed impact and/or temperature variances. For instance, a user may utilize the agitator assembly 100 to blend foodstuff containing nuts, ice, or other hard objects, and then the user may place the agitator assembly 100 in a dishwasher for cleaning.

Connector portion 140 may comprise one or more coupling tabs 144₁₋₄. The coupling tabs 144₁₋₄ may protrude or extend from a body or lead-in 142. In an aspect, the coupling tabs 144₁₋₄ may be perpendicular to an inlet or receiving chamber 146. The receiving chamber 146 may receive a portion of a drive shaft (or other component) that may attach the agitator assembly 100 to a motor. One or more of the coupling tabs 144₁₋₄ may comprise a flange or cleat 148. The cleat 148 may comprise a chamfered, beveled, 90 degree, or other formed ledge. In an aspect, the cleat 148 may be configured to couple to a lip or ledge of a drive shaft or other components, such as a drive shaft coupler. According to at least one embodiment, one or more of the coupling tabs 144₁₋₄ may comprise tab lead-ins 150 that may comprise beveled, tapered, rounded, or other edges. The tab lead-ins 150 may allow for decreased potential of damaging a cup, lid, or other portion of a container when the agitator assembly 100 is inserted or removed from a container. In one example, the tab lead-ins 150 may be formed at about 30 degrees as measured from axis 102.

It is noted that embodiments may comprise different connector portions. For instance, connector portion 140 may comprise threaded members (e.g., male or female), magnets, VELCRO, clips, straps, or other appropriate connectors. In an aspect, the type or form of connector may depend on the blender to which the agitator assembly 100 may be configured to attach. In at least one embodiment, the agitator assembly 100 may be integrally formed with a blender. For example, the arm portion 110 may be monolithically formed with a drive shaft.

Lead-in 142 may comprise an angled or tapered formation that may be generally conical shape, pyramid shape, or other shape that narrows proximal to arm portion 110 and widens proximal to coupling tabs 144₁₋₄. In an exemplary embodiment, the outer surface of the lead-in 142 may be angled at about 30 degrees from axis 102. The lead-in 142 may allow for decreased potential for damaging a cup, lid, or other portion of a container when the agitator assembly 100 is inserted or removed from a container. For example, a user may attach a lid to a container, such as a domed plastic lid having an aperture, and then may insert or position the container and lid such that at least a portion of agitator assembly 100 is disposed within the container. The sloped configuration of the lead-in 142 may provide a transition that may generally avoid catching on the lid and/or damaging the lead.

Arm portion 110 may extend from the lead-in 142 at a proximal end 114 and towards a distal end 116. Arm portion 110 may comprise a body member 112 and one or more ribs 118. The body member 112 may comprise a cylindrical or rod-like portion. In an aspect, the body member 112 may comprise a solid material and/or may comprise hollow portions. According to at least one embodiment, the body member 112 may comprise one or more materials. For instance, the body member 112 may be comprised of a food-grade plastic, metal, or the like. In an example, the body member 112 may comprise a metallic core and a plastic outer body or shell. The core may strengthen the body member 112 and/or may reduce potential for wobble.

Ribs 118 may comprise chamfered ribs extending from body member 112 that may support body member 112 and/or contribute to mixing of foodstuff. In an aspect, the chamfered ribs may prevent damage to containers. For example, the chamfered ribs may be configured to provide a surface that smoothly translates about a surface such as to prevent damage to a cup, (e.g., a foam cup). It is noted that ribs 118 may comprise other desired formations or shapes, such as beveled, rounded, or knife-like ribs. As depicted, the agitator assembly 100 may comprise four ribs 118 arranged in a plus-like configuration. In an aspect, the ribs may be generally straight from distal end 116 to proximal end 114. In at least one embodiment, the agitator assembly 100 may comprise a different number of ribs 118 (e.g., 0, 1, 2, etc.) and/or differently arranged ribs. For instance, the ribs 118 may be curved from distal end 116 to proximal end 114 or the like.

In another aspect, a length of extension 119 of the ribs 118 may generally decrease from proximal end 114 towards distal end 116. In an aspect, the length of extension 119 may gradually alter such that the ribs 118 taper and allow for a smooth transition from distal end 116 to proximal end 114 and to connector portion 140. In an aspect, the smooth transition may allow the agitator assembly 100 to be easily inserted into a container and/or lid.

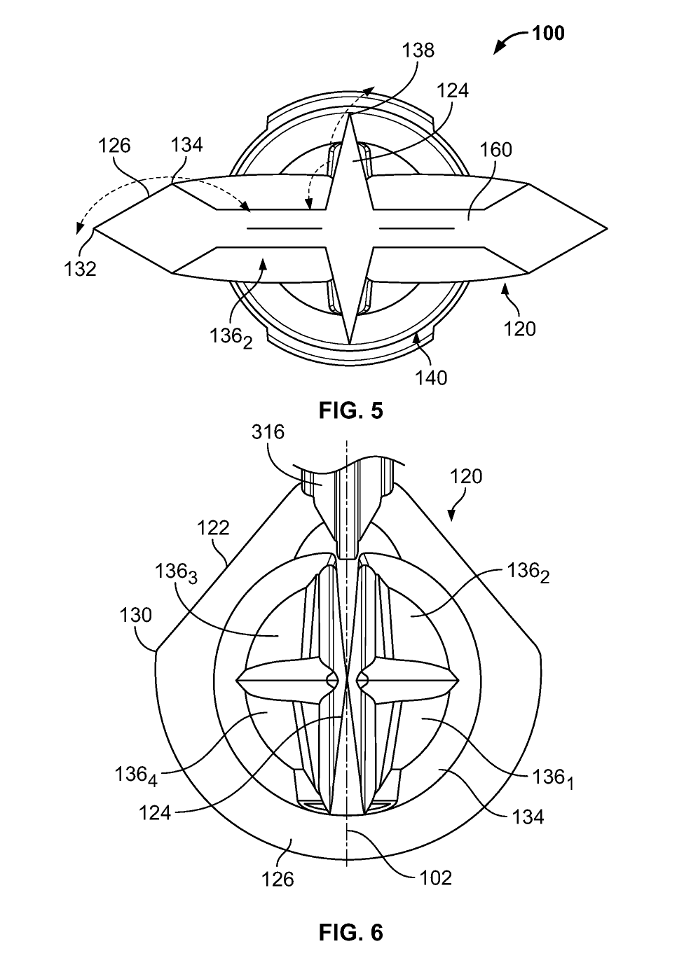

Agitator head 120 may be disposed proximal to distal end 116 of arm member 110. The agitator head 120 may comprise a diamond-like, swept-blend shape that rotates about axis 102 in the Y plane. As shown in FIG. 5, the cross-sectional shape may comprise a diamond-like shape. In an aspect, the agitator head 120 may comprise flattened area 122, protrusions 124, and a curved body or swept-blend 126. The design of the agitator head 120 may include sharp edges as described herein. The edges may force material above or beneath the edges to mix the material. In another aspect, the diamond-like, swept-blend shape may allow gravity to pull material off the agitator head 120 into a cup once the agitator head is removed from contact with foodstuff

Swept-blend 126 may comprise a distal end of agitator head 120. The swept-blend 126 may comprise a round, ring, or curved shape that may represent a portion of a circle or ellipse, as viewed along the X plane (e.g., as seen in FIGS. 1 and 5). In an aspect, the curved shape or arch extends away from the arm along the X plane. A flattened area 122 may be disposed along either side of the swept-blend 126. The flattened area 122 may comprise a generally flat surface that extends from proximal the distal end 116 to a reference point 130. Reference point 130 may generally refer to an area where the flattened area 122 and the swept-blend 126 meet.

As shown in the partial, cross-sectional view of FIG. 5 (as well as other figures), swept-blend 126 may include a point or inner edge 134. The outer edge 132 may comprise a knife-like edge. In another aspect, the outer edge 132 may be rounded, beveled, chamfered, or the like. The shape of the outer edge 132 may force movement of foodstuff during a mixing process. In another aspect, an inner edge 134 may be disposed internal to the agitator head 120. In an aspect, rotation of the agitator head 120 may force material around inner edge 134 and through one or more apertures 136₁₋₄ and/or around outer edge 132. The diamond-like feature may allow for successful blending as outer edge 132 faces out of the sweep. This may force material to go above and beneath the outer edge 132. In another aspect, material removal waste is minimized due to the diamond point on the top, with steeper edges going toward the bottom of the cup; gravity is used to pull material off the agitator assembly 100 into the cup once it is removed.

In another aspect, protrusions 124 may comprise mixing appendages or knife-like edges that protrude from proximal the axis 102 and converge on at an edge 138. The edge 138 may generally comprise a sharp or steeply angled edge. This may force foodstuff around the edge 138 and/or through one or more apertures 136₁₋₄. It is noted that the edge 138 may be rounded, beveled, or the like. Reducing the sharpness of the edge may increase efficiency of a blending process. From a top down view as shown in FIG. 4, these knife-like edges are located 90 degrees or perpendicular to the left and right of the swept-blend 126. From a side view as shown in FIG. 2 and a bottom view as shown in FIG. 4, it can be observed that these knife-like edges have a similar, but more extreme diamond-like design in comparison with swept-blend 126.

From a mixing standpoint, vertical agitation as well as horizontal agitation is very important. It is noted that swept-blend 126 and protrusions 124 may allow for thorough horizontal agitation as well as a degree of vertical agitation. Flattened area 122 may cross a portion of swept-blend 126. As described herein, the flattened area 122 may start proximal to distal end 116 and may extend to reference area 130. The flattened area 122 may comprise a general diamond-like shape or other shape, such as an oval, football-like shape, almond shape, or the like. In general, the shape may comprise a concave portion and a convex portion. The diamond-like shape may add strength to the agitation head 120.

In at least one embodiment, one or more apertures 136₁₋₄ may allow for altered (e.g., better) flow of material during a blending process. The altered flow may result in a more desirable blended product and/or may reduce the load on a motor of a blender in comparison to agitators that do not comprise apertures. While four apertures are shown, it is noted that a different number of apertures may be utilized. In another aspect, the one or more apertures 136₁₋₄ may comprise various appropriate shapes.

Embodiments may include supports or ribs that may increase the strength of various components. For instance, cross-support 160 may extend across swept-blend 126 and/or may intersect with protrusions 124. The cross-support 160 may comprise a diamond-like shape that may force material above or below the cross-support 160 during a blending process. In another aspect, the diamond-like shape may allow for removal of material from the cross-support 160 and/or may reduce wasted product. It is noted that cross-support 160 may increase the strength of the aperture head 120 and/or may increase longevity thereof. In another aspect, vertical support 162 may extend from proximal arm portion 110 (e.g., distal end 116 of arm portion 110) to swept-blend 126. Vertical support 162 and cross-support 160 may generally form a “t” or cross-like shape. It is noted that the various supports may alter (e.g., increase) tensile strength, longevity and/or overall user satisfaction. It is further noted that embodiments may include various other ribs or supports. These supports may be positioned to strengthen desired areas of agitator head 120. For instance, the supports may be disposed around areas under a threshold amount of stress, having a threshold thinness of material, or the like.

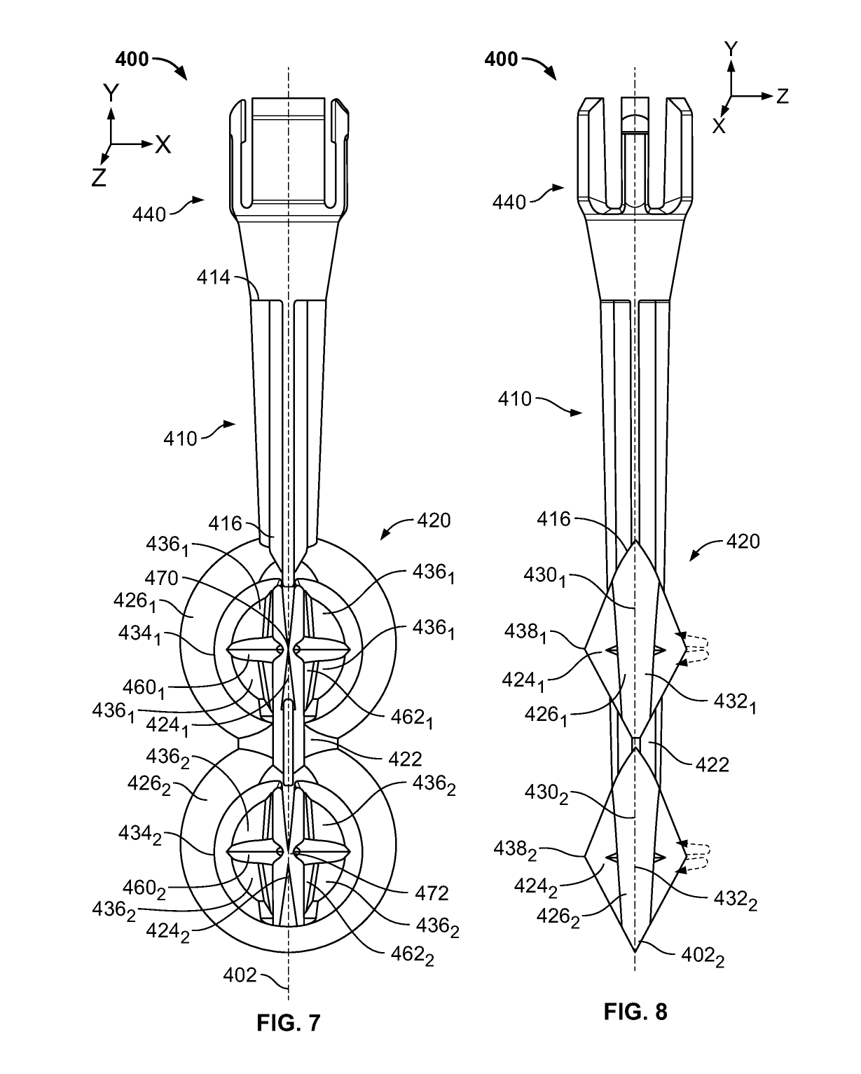

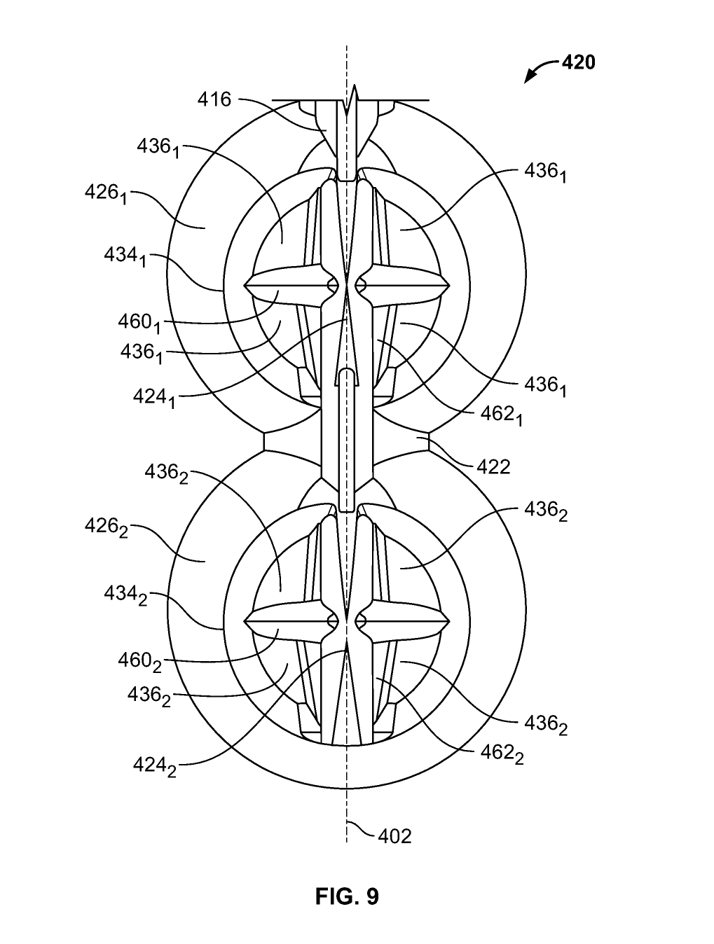

FIGS. 7-9 depict an agitator assembly 400 in accordance with one or more described embodiments. It is noted that like-named components of agitator assembly 400 and agitator assembly 100 may comprise similar aspects. For instance, arm portion 410 may comprise similar aspects as those of arm portion 110. In another aspect, connector portion 440 may comprise similar aspects as those of connector portion 140.

In at least one embodiment, agitator assembly 400 may comprise an agitator head 420 that may comprise a dual or doubled-head in comparison with agitator assembly 100. It is noted that agitator head 420 may comprise a different number of heads, such as three or four heads. Agitator head 420 may be disposed proximal to distal end 416 of arm member 410. The agitator head 420 may comprise a plurality of diamond-like, swept-blend shapes that rotate about axis 402 in the Y plane. In an aspect, the agitator head 420 may comprise protrusions 424₁₋₂, and swept-blends 426₁₋₂. The design of the agitator head 420 may include sharp edges as described herein.

Swept-blend 426₂ may comprise a distal end of agitator head 420. The swept-blends 426₁₋₂ may comprise a round or curved shape, such as a portion of a circle or ellipse. A transition area 422 may comprise a thickened portion of material that connects the swept-blend 426₁ (which may generally define a first agitator head portion) and swept-blend 426₂ (which may generally define a second agitator head portion). It is noted that the first and second agitator head portions may comprise generally similar shapes and aspects.

For instance, swept-blends 426₁₋₂ may respectively comprise points or outer edges 434₁₋₂ and inner edges 434₁₋₂. In an aspect, rotation of the agitator head 420 may force material around or through apertures of the sets of apertures 436₁₋₂. In another aspect, protrusions 424₁₋₂ may comprise mixing appendages or knife-like edges protrude from proximal the axis 402 and converge on at edges 438₁₋₂.

It is noted that embodiments may include supports or ribs that may increase the strength of various components. For instance, cross-supports 460₁₋₂ may extend across swept-blends 426₁₋₂ and/or may intersect with protrusions 424₁₋₂. In another aspect, vertical supports 462₁₋₂ may extend from proximal arm portions 410₁₋₂ (e.g., distal end 416 of arm portion 410) to swept-blends 426₁₋₂.

The agitator assembly 400 may allow for altered (e.g., improved) blending of larger portion-sized drinks, such as those above about 18 oz. Such larger portion sizes typically require taller cups. Thus, the increased vertical dimensions of agitator head 420, with respect to other agitators, may allow for improved mixing. In one example, a distance from center plane 470 to center plane 472 may be about 1.7 inches in the upward direction. Such may allow for proper fits with common cups and lids, and may allow for a thorough blend. It is noted that various other dimensions are within the scope and spirit of this disclosure. In another aspect, the dimensions may depend in part on the cup or container that may be utilized with the agitator assembly 100.

It is noted that the second agitator may comprise a cut through the end of protrusion 424₂. This cut may be configured such that the lower portion of the cup does not suffer any unwanted agitation. It is further noted that a single-headed agitator (e.g., agitator assembly 100) may comprise similar cuts as the lower agitator of a double-headed agitator (e.g., agitator assembly 400), but may include additional or different cuts on a swept-blend. These cuts may be configured to prevent unwanted contact with lids and/or cups.

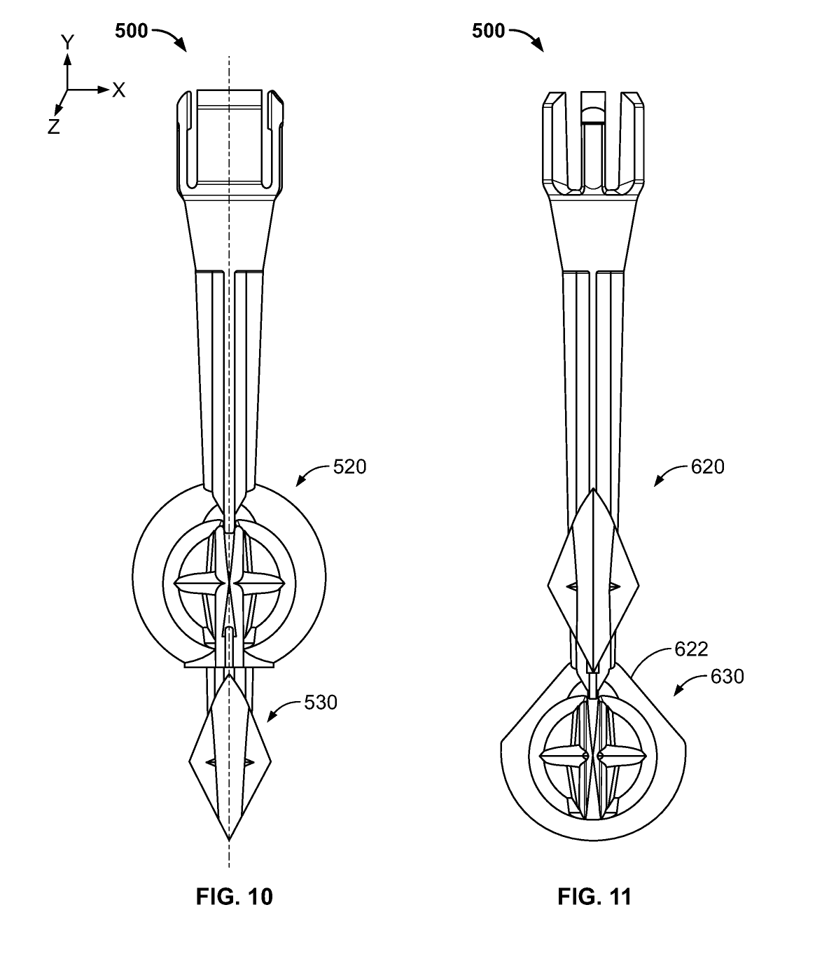

FIG. 10 is an agitator assembly 500 according to various disclosed aspects. The agitator assembly 500 may include a first agitator head 520 that may be rounded, and a second agitator head 530 that may also be rounded. FIG. 11 is an agitator assembly 600 that may comprise a first agitator head 620 that may be rounded and a second agitator head 630 that may include cut-away portions or central diamond portions 622.

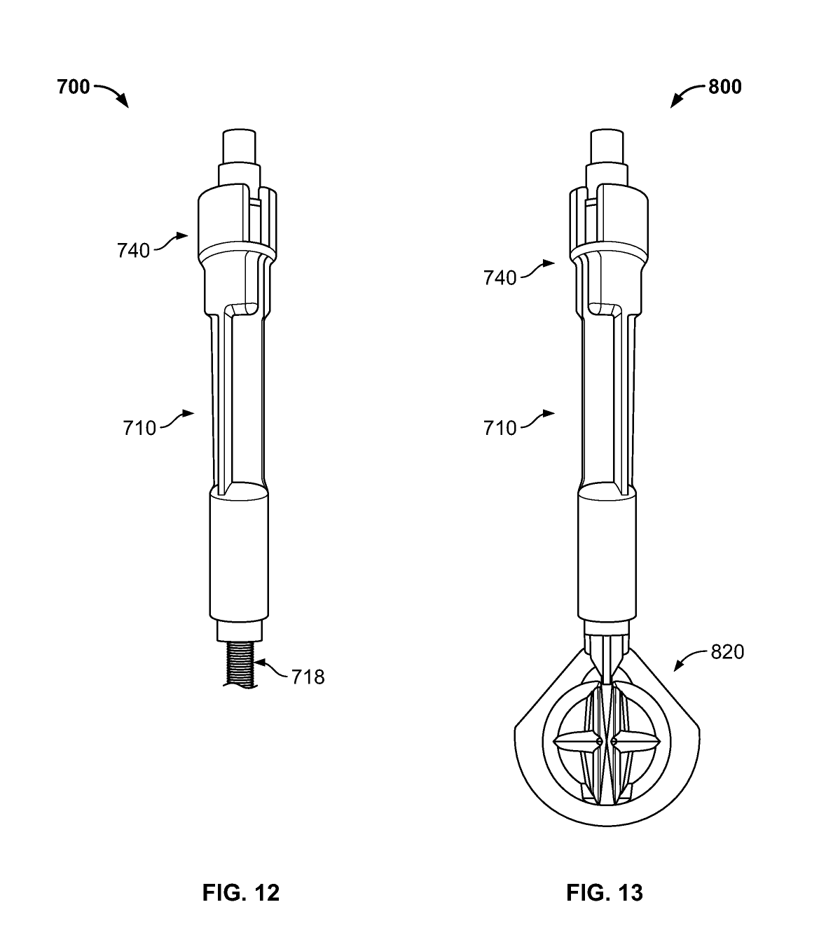

FIGS. 12 and 13 illustrate an arm attachment 700 and an agitator head 820. In an aspect, the arm attachment 700 may comprise a body or arm 710, a head attachment portion 718, and a connector portion 740 that may couple to a shaft of a blender motor. In an aspect, an agitator assembly 800 may comprise the arm attachment 700 coupled (removably or irremovably) to the agitator head 820. In an aspect, the head attachment portion 718 may comprise a threaded member or other connector that may connect to the agitator head 820.

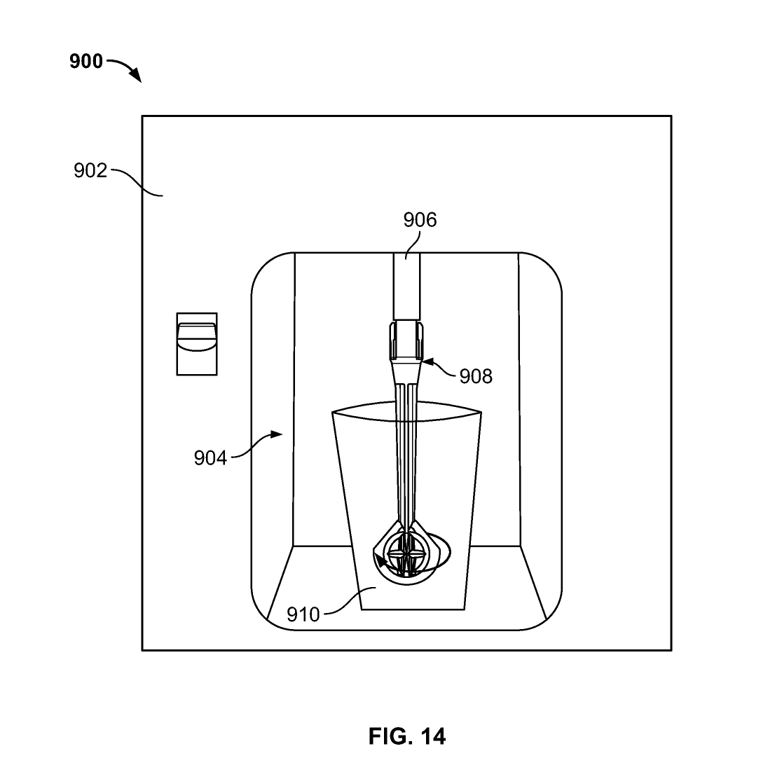

FIG. 14 is an exemplary blending system 900. Blending system 900 may include a blender device 902. The blender device 902 may include a motor connected to a power source. In an aspect, the blender device 902 may comprise a blending area 904 that may receive a container 910 for blending of foodstuff. A drive shaft 906 of a motor may be coupled to an agitator assembly 908. The agitator assembly 908 may comprise various aspects as described herein, such as a rigid agitator head 910 that may comprise a diamond-like cross-section. While blender device 902 is depicted as comprising agitator assembly 908 extending downward and/or as comprising a counter top or stand-alone device, it is noted that various other blender systems may be utilized.

Although the embodiments of the present disclosure have been illustrated in the accompanying drawings and described in the foregoing detailed description, it is to be understood that the present disclosure is not to be limited to the embodiments disclosed, but that the disclosure described herein is capable of numerous rearrangements, modifications and substitutions without departing from the scope of the claims hereafter.

1. An agitator assembly for mixing a product, the assembly comprising:
an arm member having a distal end and an opposite proximal end, wherein the proximal end is operatively attached to a shaft of a motor; and
an agitator head disposed proximal to the distal end of the shaft, the agitator head comprising a curved portion comprising an out edge defining a perimeter and an inner edge such that wherein a cross-section of the curved portion is generally diamond-like in shape.

2. The agitator assembly of claim 1, wherein the agitator head further includes at least one protrusion disposed generally perpendicular to the curved portion.

3. The agitator assembly of claim 2, wherein the at least one protrusion comprises a diamond-like shape.

4. The agitator assembly of claim 3, wherein the at least one protrusion comprises knife-like edges.

5. The agitator assembly of claim 1, a first flattened area extending from the arm to a end of the curved portion, and a second flattened area extending from the arm to a second send of the curved portion.

6. The agitator assembly of claim 1, wherein the body comprises one or more apertures.

7. The agitator assembly of claim 6, wherein the internal edge is raised relative to the external edge and the one or more aperture such that contents within a container is operatively directed through the one or more apertures and/or past the external edge.

8. The agitator assembly of claim 1, wherein a radial cross-section of the agitator head is about or less than six centimeters.

9. A blender system for mixing foodstuff, the blender system comprising:
a blender device comprising a motor and a drive shaft; and
an agitator assembly configured to extend from the drive shaft, the agitator assembly comprising:
an arm extending from the drive shaft;
a curved body extending from the arm, wherein the curved body comprises a diamond-like cross-section; and
a plurality of knife-like protrusions, wherein a cross-section of the first protrusion and a second protrusion form a diamond-like shape.

10. The agitator assembly of claim 9, wherein the agitator assembly comprises a rigid food-grade plastic.

11. The agitator assembly of claim 9, wherein the agitator assembly further comprises at least one aperture.

12. The agitator assembly of claim 11, further comprise a cross-support extending across the at least one aperture to connect opposed sides of the curved body.

13. The agitator assembly of claim 9, wherein the curved body comprises at least a partially-elliptical shape.

14. The agitator assembly of claim 9, wherein the arm further comprises a lead in portion comprising an angled surface operatively disposed proximal the drive shaft.

15. The agitator assembly of claim 9, wherein the arm comprises one or more ridges extending from a body of the arm portion.

16. The agitator assembly of claim 9, wherein the agitator assembly further comprises a connection portion disposed at a first end of the arm and removably coupling the agitator assembly to the drive shaft.

17. An agitator assembly for a blending system, the agitator assembly comprising:
an arm extending from a first end to a second end, the arm operatively attached to a blender device at the first end;
an agitator head disposed at the second end of the arm and comprising:
a curved body including an external edge about a perimeter of the body, and a inner edge, wherein a thickness of the body decreases from the inner edge towards the external edge; and
at least one aperture disposed proximal a central axis of the body, wherein the thickness of the body generally decreases from the inner edge towards the at least one aperture.

18. The agitator assembly of claim 17, wherein the agitator head further comprises at least one protrusion extending normally from the curved body.

19. The agitator assembly of claim 17, wherein the curved body extends in a direction generally downward from the arm.

20. The agitator assembly of claim 17, wherein the agitator assembly further comprises another curved body.
